(19) United States
(12) Patent Application Publication
(10) Pub. No.: US 2004/0258566 A1
(43) Pub. Date: Dec. 23, 2004

(54) Transfer apparatus

(75) Inventor: Philip Russell James Smith, Cambridge (GB)

Correspondence Address: DYKEMA GOSSETT PLLC, Third Floor West, 1300 I Street, N.W., Washington, DC, 20005, US

(73) Assignee: THE AUTOMATION PARTNERSHIP (CAMBRIDGE) LIMITED, Royston (GB)

(21) Appl. No.: 10/843,671

(22) Filed: May 12, 2004

(30) Foreign Application Priority Data
May 13, 2003 (EP) 03252959.6

(51) Int. Cl. G01N 35/00

(52) U.S. Cl. 422/65; 435/283.1; 422/100

(57) ABSTRACT

Apparatus for transferring a vial of fluid material to or from a storage plate containing a number of vials is provided. The apparatus comprises a first plunger disposed on one side of a defined storage plate support position and movable axially into engagement with a vial held in use in a storage plate at the support position to move the vial out of the storage plate in the direction away from the support position on the other side of the support position; and a closed path conveyor having one or more slots to receive a vial, selectively alignable with the axis of the first plunger.

The present invention relates to an apparatus for transferring a vial of fluid material to or from a storage plate containing a number of vials, for example for use in a biological or chemical assay or similar process.

### BACKGROUND OF THE INVENTION AND PRIOR ART

In biological and chemical assay processes and systems which operate with vials of biological or chemical material usually held in suspension or solution within a fluid in vials, the vials have to be moved around so that materials can be inserted into and removed from the vials as well as the vials being visually inspected and, conventionally, large numbers of vials are held in storage plates and transferred individually to and from the respective storage plates.

EP-A-08571032 discloses an analyser incubator which utilises two independently driven concentric incubator rings. Each ring supports and transports cuvettes containing samples between processing stations of the analyser. The motion of the cuvettes into and out of the two concentric rings is instigated by an arm which pulls the cuvettes from the ring by moving them radially inwardly or outwardly of the ring. This mechanism is limited to use within one set of incubator rings as the motion must be radially inwardly or outwardly relative to the axis of rotation of the incubator rings. Furthermore, the method of disengaging the cuvettes from the incubator ring, namely forcing the cuvette radially inwardly by applying a force to the upper side portion of the cuvette, relies heavily on the shape of the cuvette and inherently requires an individually formed cuvette with tapered sides. Furthermore, this method of disengaging cuvettes from incubator rings inherently involves a given degree of tipping of the cuvette during disengagement from the incubator ring. This can cause the contents of the cuvette to spill and may result in cross-contamination between samples and partial loss of samples.

EP-A-1037050 discloses a series of three interconnected drums that make up a diagnostic measuring device. The three drums overlap and a series of plungers allow sample cup cassettes to be pushed vertically from one drum into another.

WO 01/54817 discloses an automatic biological analysis apparatus using cuvettes and means for transferring the cuvettes inside such an apparatus. A series of stacked carousels and a transfer method are disclosed whereby a transfer fork pushes a cuvette between indexed positions on the various stacked carousels.

It is increasing necessary to process a large number of samples and, in all of the above described systems, the number of samples is strictly limited by the size of the carousels, drums or incubator rings. The aim of the present invention is to increase the number of samples that can be dealt with by a single transfer device. In particular, the plunger and closed path conveyer of the present invention are capable of movement in the x-y plane relative to the supported vials. This enables the transfer device to move between different sets of vials thereby reducing the amount of equipment required for dealing with a given number of samples.

A further system requirement is that the vials be examined by means of a bar code or dot code reader. When the transfer apparatus has access to a large number of samples a “pick and place” robot removes a vial from an associated plate to a code reader and after the code has been read, moves the vial back to a storage plate or else to a different location. As a result of the large number of vials that can be accessed by the transfer apparatus, the move to and from the code reader takes a relatively long time.

### SUMMARY OF THE PRESENT INVENTION

According to the present invention there is provided apparatus for transferring a vial of fluid material to or from a storage plate containing a number of vials, the apparatus comprising:

a first plunger disposed on one side of a defined storage plate support position and movable axially into engagement with a vial held in use in a storage plate at the support position to move the vial out of the storage plate in the direction away from the support position on the other side of the support position; and

a closed path conveyor having one or more slots to receive a vial, selectively alignable with the axis of the first plunger.

The apparatus may further comprise a second plunger disposed on the other side of the conveyor and the support position from the first plunger and movable axially into engagement with a vial held in use in a slot in the conveyor to move the vial out of the conveyor.

Preferably, the second plunger is disposed in axial alignment with the first plunger for moving a vial back from the conveyor into a storage plate.

Preferably, the closed path conveyor has an axis of rotation at an angle to the axis of the first plunger and wherein the slots for receiving the vials are disposed at the same angle to the axis of the conveyor.

Advantageously, the conveyor is a wheel.

Preferably, the apparatus further comprises a plate support at the plate support position.

The first plunger and the conveyor are preferably movable parallel to the plate support to plural locations to allow the plunger to align with a given vial held in the support plate, together with the second plunger.

An optical code reader may be mounted to scan a vial disposed in the or each slot as the conveyor rotates and a mirror may be disposed adjacent the conveyor to allow remote inspection of the vials held in the slots in the conveyor by the optical code reader.

Such a transfer apparatus has a considerable benefit over prior art devices in the speed of operation. By providing multiple slots in the conveyor, the first plunger can move plural vials from the storage plate into the conveyor, in quick succession, moving only small distances (the distance between adjacent vial positions in the support plate) between each operation.

By mounting the code reader remote from the conveyor and utilising a mirror disposed adjacent the conveyor, remote reading of the codes on the vials can be achieved from positions on the conveyor wheel remote from the axis of the plungers, so that the code on a given vial can be read while a second vial is being removed from or inserted into the storage plate.

Of course, the second plunger could be disposed out of alignment with the first plunger so as to provide a mechanism for transferring vials on the conveyor wheel to a further conveyor or further plate for onward further processing.

Conventionally, a batch of vials is selectively removed from the storage plate for further processing and then a new batch of vials is inserted into the plate as a separate process. With the apparatus of the present invention there are speed benefits from combining the removal and insertion processes. For example, if the conveyor has 13 slots for vials then up to 12of the slots could be filled in quick succession with new vials being placed into the conveyor from an input carrier plate, the transfer apparatus then moving the conveyor to the location of a vial to be removed from the storage plate and that vial being moved into the 13th space in the conveyor, so that the conveyor can then be rotated and a new vial inserted into the storage location in the storage plate just vacated by the vial last removed from the storage plate into the conveyor. This “swapping” process can then be continued on the remaining new vials in the conveyor and once all of the vials have been swapped the conveyor wheel can be moved to an output carried plate and the vials placed into the carried plate in quick succession.

It is envisaged that the conveyor could include slots of different sizes so as to enable vials of different sizes to be selectively retained and transferred by the conveyor wheel in systems which operate using vials of different sizes for different purposes.

### DESCRIPTION OF THE DRAWINGS

FIG. 1 shows an exemplary apparatus according to the present invention described with reference to the accompanying diagrammatic side elevation of the apparatus.

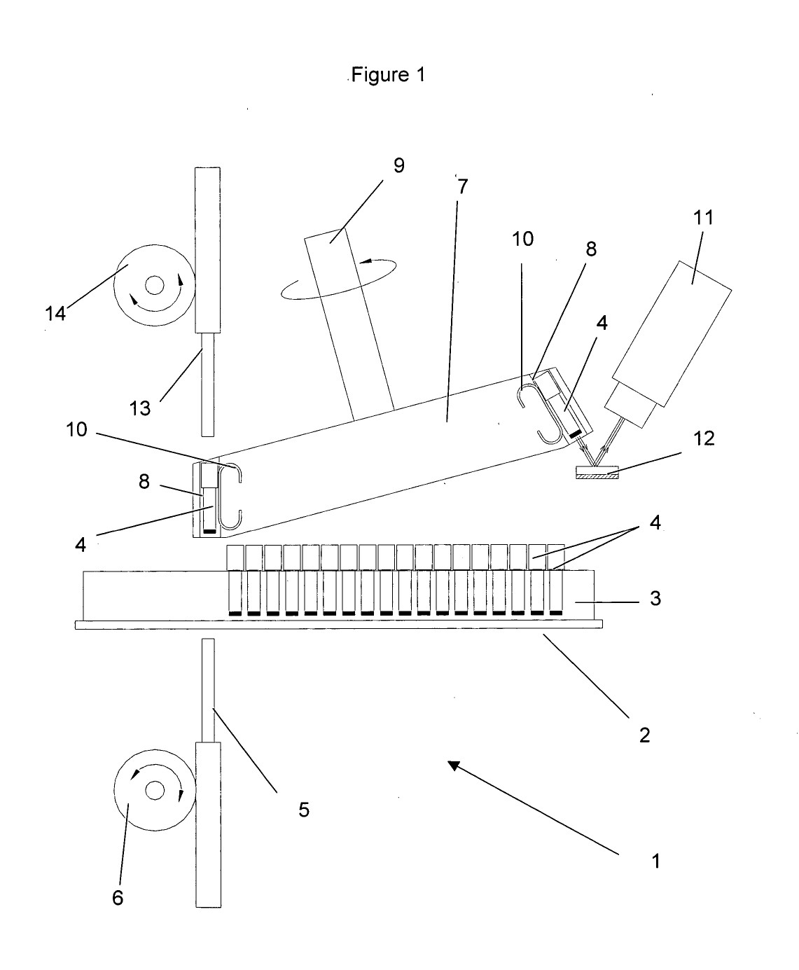

### DETAILED DESCRIPTION OF THE INVENTION

The transfer apparatus 1 has a support 2 defining the location of a storage plate 3 which contains a plurality of vials 4 disposed closely adjacent one another in a grid-like array. The support 2 holds the lower edges of the plate 3 providing access through the bottom of the plate for a first plunger 5 which has a drive mechanism 6 allowing the plunger 5 to move upwardly and downwardly into and out of engagement with selected vials 4 in the plate 3. The plunger 5 is movable in the plane of the support 2 by a suitable x-y drive mechanism (not shown) so as to be capable of engaging with any vial held in the plate. In this example of the present invention the plunger 5 engages with the vial 4 merely by abutting the lower part of the vial 4 and applying a force in an upward direction. Alternatively a gripping means mounted on the plunger 5 may be used to engage with the vial 4 for improved stability.

Above the support 2 and the vial-carrying storage plate 3, there is disposed a closed path conveyor in the form of a wheel 7 which contains a series of slots or bores 8 around its periphery. The rotary axis 9 of the wheel is disposed an angle ∀ to the axis of the plunger 5 and the slots 8 are disposed at the same angle ∀ to the rotary axis 9 so that each slot can, in turn, be aligned with the plunger 5 and a vial 4 held in the storage plate 3. In the figure a vial 4 is shown held in a slot 8 in alignment with the plunger 5, having been moved into the slot 8 by operation of the plunger 5 upwardly as shown in the drawing. The vials 4 are held in the slots 8 by a suitable C-shaped spring 10 on one side of the slot 8.

At a suitable position, in the present example substantially diametrically opposed to the axis of the plunger 5 about the rotary axis 9, an optical code on the bottom of a vial 4 can be read by means of a code reader 11 which views the bottom of the vial 4 via a mirror 12.

Disposed above the conveyor wheel 7 is a second plunger 13, substantially identical to the first plunger 5 and driven by a corresponding drive mechanism 14. The axis of the plunger 13 is aligned with the axis of the plunger 5 and the plunger 13 can be operated to push a vial 4 from the conveyor wheel 7 back into a location in the storage plate 3.

It will be appreciated, that additional plungers could be disposed for engagement with vials held in the conveyor wheel 7 at different positions, so that transfer to a second mechanism out of the conveyor wheel can be achieved if desired. However, by mounting the first and second plungers 5,13 and the conveyor wheel on a common carriage for movement by the x-y drive mechanism (not shown) parallel to the plane of the storage plate 3, and allowing the components to be moved together to a further location and a separate storage plate, vials can be moved into and out of desired locations quickly, by loading the transfer wheel at one location and emptying it at another, avoiding the need for additional plungers to remove vials from the transfer wheel.

If desired, the storage plates 3 may themselves be put on appropriate conveyors so as to be movable into and out of desired locations within the particular system within which the transfer apparatus is located.

1. Apparatus for transferring a vial of fluid material to or from a storage plate containing a number of vials, the apparatus comprising:
a first plunger disposed on one side of a defined storage plate support position and movable axially into engagement with a vial held in use in a storage plate at the support position to move the vial out of the storage plate in the direction away from the support position on the other side of the support position;
a closed path conveyor having one or more slots to receive a vial, selectively alignable with the axis of the first plunger; and
wherein the first plunger and the conveyor are movable parallel to the plate support position to plural locations to allow the plunger to align with a given vial held in the support plate.

2. Apparatus according to claim 1, further comprising a second plunger disposed on the other side of the conveyor and the support position from the first plunger and movable axially into engagement with a vial held in use in a slot in the conveyor to move the vial out of the conveyor.

3. Apparatus according to claim 1, wherein the second plunger is disposed in axial alignment with the first plunger for moving a vial back from the conveyor into a storage plate.

4. Apparatus according to claim 1, wherein the closed path conveyor has an axis of rotation at an angle to the axis of the first plunger and wherein the slots for receiving the vials are disposed at the same angle to the axis of the conveyor.

5. Apparatus according to claim 4, wherein the conveyor is a wheel.

6. Apparatus according to claim 1, further including a plate support at the plate support position.

7. Apparatus according to claim 3, wherein the second plunger is movable parallel to the plate support position to plural locations to allow the plunger to align with a given vial held in the support plate.

8. Apparatus according to claim 1, further including an optical code reader mounted to scan a vial disposed in the or each slot as the conveyor rotates.

9. Apparatus according to claim 8, further including a mirror disposed adjacent the conveyor to allow remote inspection of the vials held in the slots in the conveyor by the optical code reader.
